(19) United States
(12) Patent Application Publication
(10) Pub. No.: US 2008/0189632 A1
(43) Pub. Date: Aug. 7, 2008

(54) Severity Assessment For Performance Metrics Using Quantitative Model

(75) Inventors: Ian Tien, Seattle, WA (US); Corey J. Hulen, Sammamish, WA (US); Chen-I Lim, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/670,444

(22) Filed: Feb. 2, 2007

(51) Int. Cl. G06F 3/048; G06F 17/18; G06F 15/00

(52) U.S. Cl. 715/764; 702/182; 702/179

(57) ABSTRACT

Performance metric scores are computed and aggregated by determining status bands based on boundary definitions and relative position of an input value within the status bands. A behavior of the score within a score threshold in response to a behavior of the input is defined based on a status indication scheme. Users may be enabled to define or adjust computation parameters graphically. Once individual scores are computed, aggregation for different levels may be performed based on a hierarchy of the metrics and rules of aggregation.

### BACKGROUND

Key Performance Indicators (KPIs) are quantifiable measurements that reflect the critical success factors of an organization ranging from income that comes from return customers to percentage of customer calls answered in the first minute. Key Performance Indicators may also be used to measure performance in other types of organizations such as schools, social service organizations, and the like. Measures employed as KPI within an organization may include a variety of types such as revenue in currency, growth or decrease of a measure in percentage, actual values of a measurable quantity, and the like.

The core to scorecarding is the calculation of a score that represents performance across KPIs, their actual data, their target settings, their thresholds and other constraints. All metrics are, however, not equal. In most practical scenarios, different KPIs reporting to higher level ones have different severity levels. Ultimately most performance analysis comes down to a quantitative decision about resource allocation based on metrics such as budget, compensation, time, future investment, and the like. Since each of the metrics feeding into the decision process may have a different severity level, a confidently and accurately made decision requires assessment of metrics considering their severity levels among other aspects.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to computing scores of performance metrics by determining status bands based on boundary definitions and a relative position of an input value within the status bands. The scores may then be aggregated to obtain scores for higher level metrics utilizing predetermined aggregation rules.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an example scorecard architecture;

FIG. 2 illustrates a screenshot of an example scorecard;

FIG. 3 is a diagram illustrating scorecard calculations for two example metrics using normalized banding;

FIG. 4 illustrates four examples of determination of scores by setting boundary values and associated input and score thresholds;

FIG. 5 illustrates different aggregation methods for reporting metrics in an example scorecard;

FIG. 6 is a screenshot of a performance metric definition user interface for performing scorecard computations according to embodiments;

FIG. 7 is a screenshot of a performance metric definition user interface for defining an input value according to one method;

FIG. 8 is a screenshot of a performance metric definition user interface for defining an input value according to another method;

FIG. 9 is a screenshot of a performance metric definition user interface for defining input thresholds;

FIG. 10 is a screenshot of a performance metric definition user interface for defining score thresholds;

FIG. 11 is a screenshot of a performance metric definition user interface for testing the effects of proximity of a test input value to other input values;

FIG. 12 is a diagram of a networked environment where embodiments may be implemented;

FIG. 13 is a block diagram of an example computing operating environment, where embodiments may be implemented; and

FIG. 14 illustrates a logic flow diagram for a process of severity assessment for performance metrics using a quantitative model.

### DETAILED DESCRIPTION

As briefly described above, performance metric scores may be computed based on comparison of actuals and targets of performance metrics by determining status bands from boundary definitions and determining a relative position of an input value within the status band. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

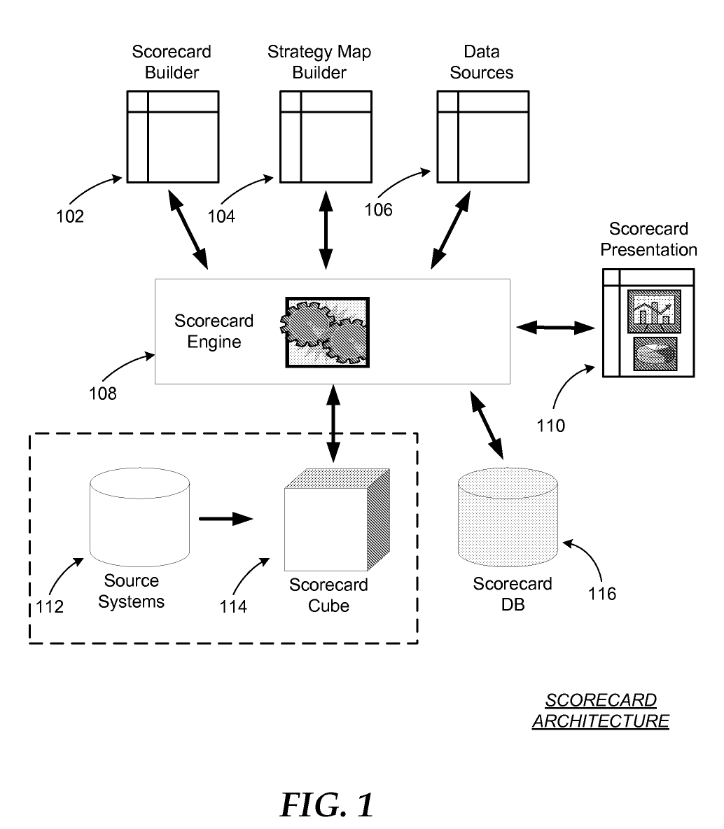

Referring to FIG. 1, an example scorecard architecture is illustrated. The scorecard architecture may comprise any topology of processing systems, storage systems, source systems, and configuration systems. The scorecard architecture may also have a static or dynamic topology.

Scorecards are an easy method of evaluating organizational performance. The performance measures may vary from financial data such as sales growth to service information such as customer complaints. In a non-business environment, student performances and teacher assessments may be another example of performance measures that can employ scorecards for evaluating organizational performance. In the exemplary scorecard architecture, a core of the system is scorecard engine 108. Scorecard engine 108 may be an application software that is arranged to evaluate performance metrics. Scorecard engine 108 may be loaded into a server, executed over a distributed network, executed in a client device, and the like.

Data for evaluating various measures may be provided by a data source. The data source may include source systems 112, which provide data to a scorecard cube 114. Source systems 112 may include multi-dimensional databases such OLAP, other databases, individual files, and the like, that provide raw data for generation of scorecards. Scorecard cube 114 is a multi-dimensional database for storing data to be used in determining Key Performance Indicators (KPIs) as well as generated scorecards themselves. As discussed above, the multi-dimensional nature of scorecard cube 114 enables storage, use, and presentation of data over multiple dimensions such as compound performance indicators for different geographic areas, organizational groups, or even for different time intervals. Scorecard cube 114 has a bi-directional interaction with scorecard engine 108 providing and receiving raw data as well as generated scorecards.

Scorecard database 116 is arranged to operate in a similar manner to scorecard cube 114. In one embodiment, scorecard database 116 may be an external database providing redundant back-up database service.

Scorecard builder 102 may be a separate application or a part of a business logic application such as the performance evaluation application, and the like. Scorecard builder 102 is employed to configure various parameters of scorecard engine 108 such as scorecard elements, default values for actuals, targets, and the like. Scorecard builder 102 may include a user interface such as a web service, a GUI, and the like.

Strategy map builder 104 is employed for a later stage in scorecard generation process. As explained below, scores for KPIs and other metrics may be presented to a user in form of a strategy map. Strategy map builder 104 may include a user interface for selecting graphical formats, indicator elements, and other graphical parameters of the presentation.

Data Sources 106 may be another source for providing raw data to scorecard engine 108. Data sources 106 may also define KPI mappings and other associated data.

Additionally, the scorecard architecture may include scorecard presentation 110. This may be an application to deploy scorecards, customize views, coordinate distribution of scorecard data, and process web-specific applications associated with the performance evaluation process. For example, scorecard presentation 110 may include a web-based printing system, an email distribution system, and the like. In some embodiments, scorecard presentation 110 may be an interface that is used as part of the scorecard engine to export data for generating presentations or other forms of scorecard-related documents in an external application. For example, metrics, reports, and other elements (e.g. commentary) may be provided with metadata to a presentation application (e.g. PowerPoint® of MICROSOFT CORPORATION of Redmond, Wash.), a word processing application, or a graphics application to generate slides, documents, images, and the like, based on the selected scorecard data.

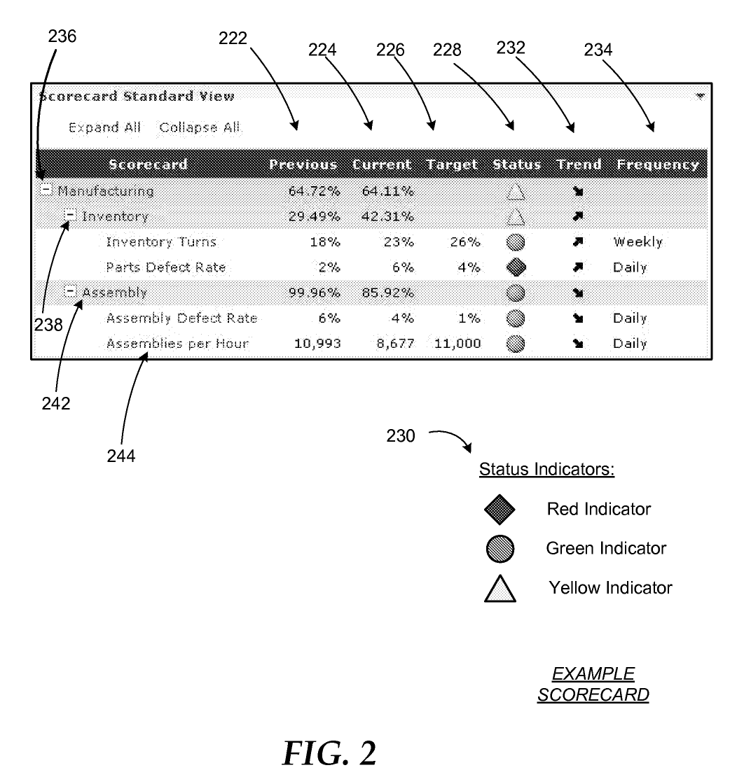

FIG. 2 illustrates a screenshot of an example scorecard with status indicators 230. As explained before, Key Performance Indicators (KPIs) are specific indicators of organizational performance that measure a current state in relation to meeting the targeted objectives. Decision makers may utilize these indicators to manage the organization more effectively.

When creating a KPI, the KPI definition may be used across several scorecards. This is useful when different scorecard managers might have a shared KPI in common. This may ensure a standard definition is used for that KPI. Despite the shared definition, each individual scorecard may utilize a different data source and data mappings for the actual KPI.

Each KPI may include a number of attributes. Some of these attributes include frequency of data, unit of measure, trend type, weight, and other attributes.

The frequency of data identifies how often the data is updated in the source database (cube). The frequency of data may include: Daily, Weekly, Monthly, Quarterly, and Annually.

The unit of measure provides an interpretation for the KPI. Some of the units of measure are: Integer, Decimal, Percent, Days, and Currency. These examples are not exhaustive, and other elements may be added without departing from the scope of the invention.

A trend type may be set according to whether an increasing trend is desirable or not. For example, increasing profit is a desirable trend, while increasing defect rates is not. The trend type may be used in determining the KPI status to display and in setting and interpreting the KPI banding boundary values. The arrows displayed in the scorecard of FIG. 2 indicate how the numbers are moving this period compared to last. If in this period the number is greater than last period, the trend is up regardless of the trend type. Possible trend types may include: Increasing Is Better, Decreasing Is Better, and On-Target Is Better.

Weight is a positive integer used to qualify the relative value of a KPI in relation to other KPIs. It is used to calculate the aggregated scorecard value. For example, if an Objective in a scorecard has two KPIs, the first KPI has a weight of 1, and the second has a weight of 3 the second KPI is essentially three times more important than the first, and this weighted relationship is part of the calculation when the KPIs' values are rolled up to derive the values of their parent metric.

Other attributes may contain pointers to custom attributes that may be created for documentation purposes or used for various other aspects of the scorecard system such as creating different views in different graphical representations of the finished scorecard. Custom attributes may be created for any scorecard element and may be extended or customized by application developers or users for use in their own applications. They may be any of a number of types including text, numbers, percentages, dates, and hyperlinks.

One of the benefits of defining a scorecard is the ability to easily quantify and visualize performance in meeting organizational strategy. By providing a status at an overall scorecard level, and for each perspective, each objective or each KPI rollup, one may quickly identify where one might be off target. By utilizing the hierarchical scorecard definition along with KPI weightings, a status value is calculated at each level of the scorecard.

First column of the scorecard shows example top level metric 236 “Manufacturing” with its reporting KPIs 238 and 242 “Inventory” and “Assembly”. Second column 222 in the scorecard shows results for each measure from a previous measurement period. Third column 224 shows results for the same measures for the current measurement period. In one embodiment, the measurement period may include a month, a quarter, a tax year, a calendar year, and the like.

Fourth column 226 includes target values for specified KPIs on the scorecard. Target values may be retrieved from a database, entered by a user, and the like. Column 228 of the scorecard shows status indicators 230.

Status indicators 230 convey the state of the KPI. An indicator may have a predetermined number of levels. A traffic light is one of the most commonly used indicators. It represents a KPI with three-levels of results—Good, Neutral, and Bad. Traffic light indicators may be colored red, yellow, or green. In addition, each colored indicator may have its own unique shape. A KPI may have one stoplight indicator visible at any given time. Other types of indicators may also be employed to provide status feedback. For example, indicators with more than three levels may appear as a bar divided into sections, or bands. Column 232 includes trend type arrows as explained above under KPI attributes. Column 234 shows another KPI attribute, frequency.

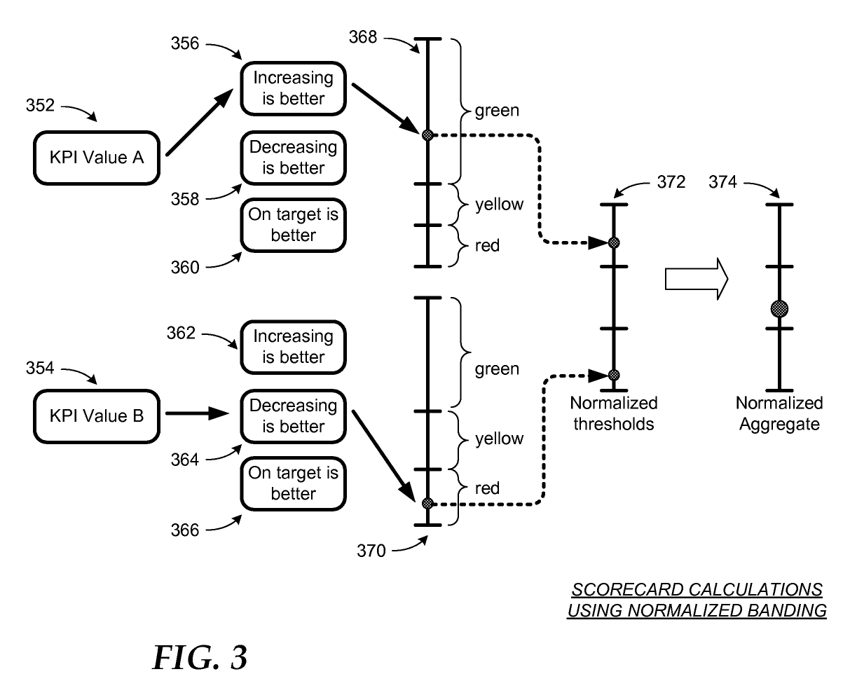

FIG. 3 is a diagram illustrating scorecard calculations for two example metrics using normalized banding. According to a typical normalized banding calculation, metrics such as KPI A (352) are evaluated based on a set of criteria such as “Increasing is better” (356), “Decreasing is better” (358), or “On target is better” (360). Depending on a result of the evaluation of the metric an initial score is determined on a status band 368 where the thresholds and band regions are determined based on their absolute values. The band regions for each criterion may be assigned a visual presentation scheme such as coloring (red, yellow, green), traffic lights, smiley icons, and the like.

A similar process is applied to a second metric KPI B (354), where the initial score is in the red band region on status band 370 as a result of applying the “Increasing is better” (362), “Decreasing is better” (364), or “On target is better” (366) criteria.

Then, the initial scores for both metrics are carried over to a normalized status band 372, where the boundaries and regions are normalized according to their relative position within the status band. The scores can only be compared and aggregated after normalization because their original status bands are not compatible (e.g. different boundaries, band region lengths, etc.). The normalization not only adds another layer of computations, but is also in some cases difficult to comprehend for users.

Once the normalized scores are determined, they can be aggregated on the normalized status band providing the aggregated score for the top level metric or the scorecard. The performance metrics computations in a typical scorecard system may include relatively diverse and complex rules such as:
Performance increases as sales approaches the sales target, after which time bonus performance is allotted
Performance increases as server downtime approaches 0.00%
Performance is at a maximum when the help desk utilization rate is at 85%, but performance decreases with either positive or negative variance around this number
Performance reaches a maximum as the volume of goods being shipped approaches the standard volume of a fully loaded truck; if the volume exceeds this value, performance immediately reaches a minimum until it can reach the size of two fully loaded trucks
The performance of all the above indicators is averaged and assessed, though
   some allow for performance bonus and some do not
   the performance of some may be considered more important than others
   some may be missing data

The ability to express these complex rules may become more convoluted in a system using normalized status bands. At least, it is harder to visually perceive the flow of computations.

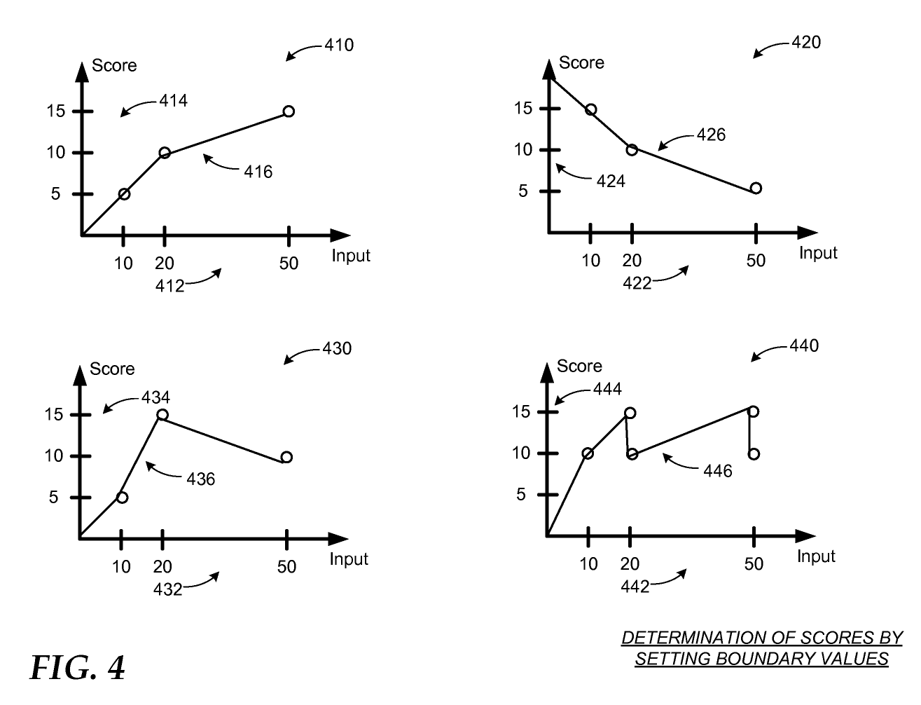

FIG. 4 illustrates four examples of determination of scores by setting boundary values and associated input and score thresholds. Score can then be computed based on the relationship between the input and score thresholds. Providing a straight forward visually adapted model for computing performance metric scores may enable greater objectivity, transparency, and consistency in reporting systems, reduce the risk of multiple interpretations of the same metric, and enhance the ability to enforce accountability throughout an organization. Thus, powerful and yet easy-to-understand quantitative models for assessing performance across an array of complex scenarios may be implemented.

As shown in chart 410, input ranges may be defined along an input axis 412. The regions defined by the input ranges do not have to normalized or equal. Next, the score ranges are defined along the score axis. Each score range corresponds to an input range. From the correspondence of the input and score ranges, boundary values may be set on the chart forming the performance contour 416. The performance contour shows the relationship between input values across the input axis and scores across the score axis. In a user interface presentation, the performance contour may be color coded based on the background color of each band within a given input range. In the example chart 410, the performance contour 416 reflects an increasing is better type trend. By using the performance contour, however, an analysis of applicable trend is no longer needed. Based on the definition of input and score thresholds, the trend type is automatically provided.

Example chart 420 includes input ranges along input axis 422 and score ranges along score axis 424. The performance contour 426 for this example matches a decreasing is better type trend. Example chart 430 includes input ranges along input axis 432 and score ranges along score axis 434. The performance contour 436 for this example matches an on target is better type trend.

Example chart 440 illustrates the ability to use discontinuous ranges according to embodiments. Input ranges are shown along input axis 422 and score ranges along score axis 424 again. The boundary values in this example are provided in a discontinuous manner. For example, there are two score boundary values corresponding to the input boundary value “20” and similarly two score boundary values corresponding to input boundary value “50”. Thus, a saw tooth style performance contour 446 is obtained.

As will be discussed later, a graphics based status band determination according to embodiments enables a subscriber to modify the bands and the performance contour easily and intuitively. In an authoring user interface, the subscriber can simply move the boundary values around on the chart modifying the performance contour, and thereby, a relationship between the input values and the scores.

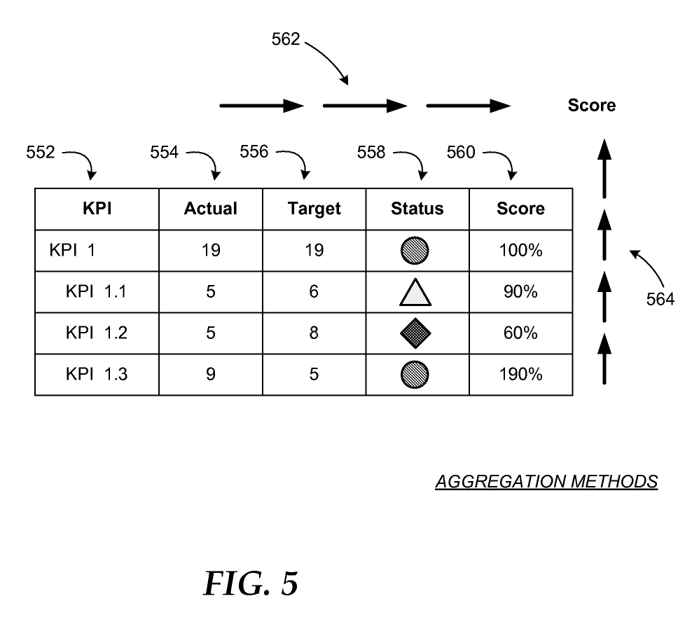

FIG. 5 illustrates different aggregation methods for reporting metrics in an example scorecard. An important part of scorecard computations after calculating the scores for each metric is aggregating the scores for higher level metrics and/or for the overall scorecard.

The example scorecard in FIG. 5 includes a top level metric KPI 1 and three reporting metrics KPI 1.1-1.3 in metric column 552. Example actuals and targets for each metric are shown in columns 554 and 556. Upon determining status bands and input values for each metric status indicators may be shown in status column 558. These may be according to visualization scheme selected by the subscriber or by default. In the example scorecard a traffic light scheme is shown. The scores, computed using the performance contour method described above, are shown in column 560. The percentage scores of the example scorecard are not a result of accurate calculation. They are for illustration purposes only. Furthermore, a scorecard may include metrics in a much more complex hierarchical structure with multiple layers of child and parent metrics, multiple targets for each metric, and so on. The status determination and score computation principle remain the same, however.

Once the scores for lower level metrics are computed, the scores for higher level metrics or for the whole scorecard may be computed by aggregation or by comparison. For example, a relatively simple comparison method of determining the score for top level KPI 1 may include comparing the aggregated actual and target values of KPI 1.

Another method may involve aggregating the scores of KPI 1's descendants or children (depending on the hierarchical structure) by applying a subscriber defined or default rule. The rules may include, but are not limited to, sum of child scores, mean average of child scores, maximum of child scores, minimum of child scores, sum of descendant scores, mean average of descendant scores, maximum of descendant scores, minimum of descendant scores, and the like.

Yet another method may include comparison of child or descendant actual and target values applying rules such as: a variance between an aggregated actual and an aggregated target, and a standard deviation between an aggregated actual and an aggregated target, and the like. According to further methods, a comparison to an external value may also be performed.

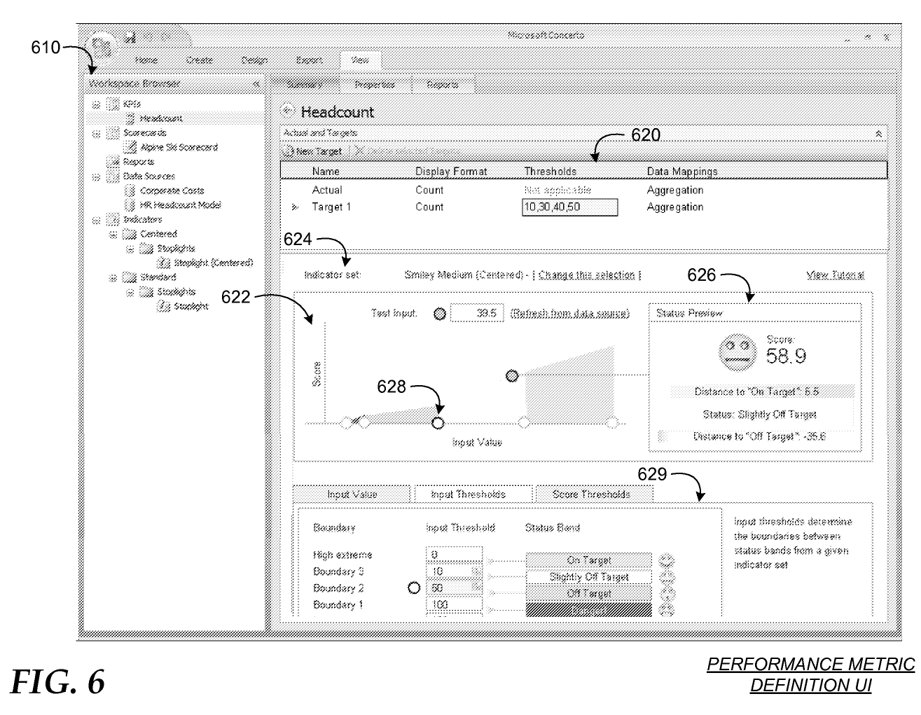

FIG. 6 is a screenshot of a performance metric definition user interface for performing scorecard computations according to embodiments. As described above in more detail, performance metric operations begin with collection of metric data from multiple sources, which may include retrieval of data from local and remote data stores. Collected data is then aggregated and interpreted according to default and subscriber defined configuration parameters of a business service. For example, various metric hierarchies, attributes, aggregation methods, and interpretation rules may be selected by a subscriber from available sets.

The core to scorecarding is the calculation of a score that represents performance across KPIs, their actual data, their target settings, their thresholds and other constraints. According to some embodiments, the scoring process may be executed as follows:

1) Input value for a KPI target is determined
a. Input can come from a variety of data sources or be user-entered

2) Status band is determined
a. A KPI target has status bands defined by boundaries. Based on those boundaries and the input value a status band is selected
b. This determines the status icon, text and other properties to be shown in the visualization of a KPI

3) Relative position of input value within status band is determined
a. The relative distance between boundary values within a status band is determined

4) A score is computed
a. Based on the relative position of the input value to the status band boundaries and the range of scores available within the status band

5) The score can then be used to determine performance downstream
a. The score of one KPI can thus be used to inform higher levels of performance based on summaries of the base KPI.

Once the aggregation and interpretation is accomplished per the above process, the service can provide a variety of presentations based on the results. In some cases, the raw data itself may also be presented along with the analysis results. Presentations may be configured and rendered employing a native application user interface or an embeddable user interface that can be launched from any presentation application such as a graphics application, a word processing application, a spreadsheet application, and the like. Rendered presentations may be delivered to subscribers (e.g. by email, web publishing, file sharing, etc.), stored in various file formats, exported, and the like.

Returning to FIG. 6, side panel 610 titled “Workspace Browser” provides a selection of available scorecards and KPIs for authoring, as well as other elements of the scorecards such as indicators and reports. A selected element, “headcount”, from the workspace browser is shown on the main panel 620.

The main panel 620 includes a number of detailed aspects of performance metric computation associated with “headcount”. For example display formats, associated thresholds, and data mapping types for actuals and targets of “headcount” are displayed at the top. The indicator set (624) is described and a link provided for changing to another indicator set (in the example Smiley style indicators are used). A preview of the performance contour reflecting scores vs. input values (622) is provided as well. The bands as defined by the boundaries (e.g. 628) are color coded to show the visualization scheme for status. A test input value is displayed on the performance contour linked to the status preview (626), which illustrates the status, indicator, score and distances to the boundaries for the test input value.

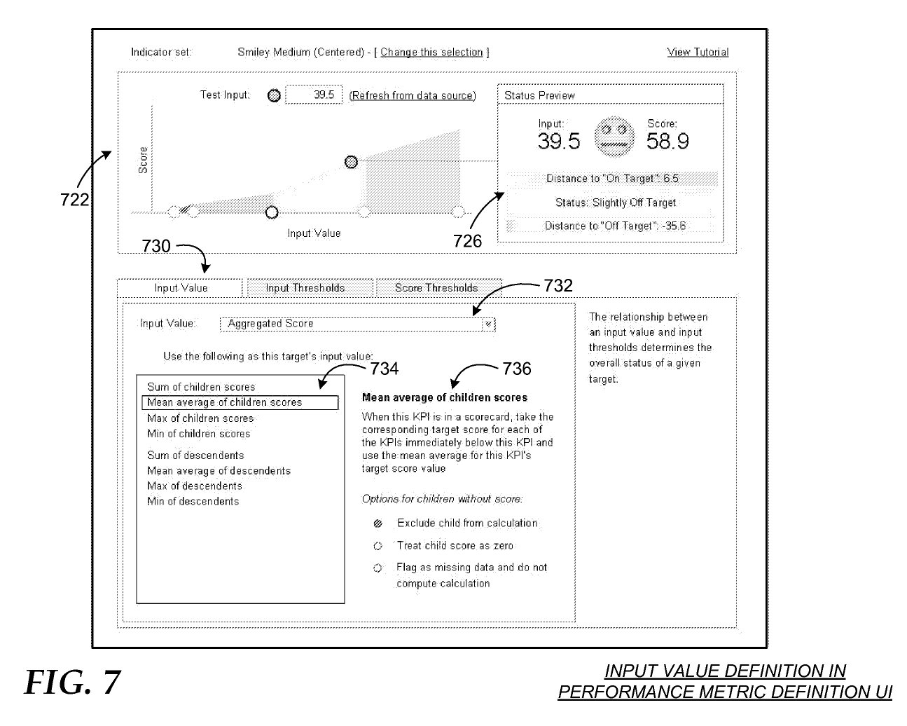

Under the preview displays, an authoring user interface 629 is provided for displaying, defining, and modifying input value, input threshold, and score threshold parameters. These are explained in more detail below in conjunction with FIG. 7 through FIG. 10.

FIG. 7 is a screenshot of a performance metric definition user interface for defining an input value according to one method. A relationship between an input value and input thresholds determines the overall status of a given target.

The example user interface of FIG. 7 includes the previews of the performance contour (722) and status (726) for a test input value as explained above in conjunction with FIG. 6. The definition section 730 of the user interface may be in a tab, pane, or pop-up window format with a different user interface for each of the input values, input thresholds, and score thresholds. The input values may be based on an aggregated score (732) or a value from the selected metric. If the input value is an aggregated score, the aggregation may be performed applying a default or subscriber defined rule. In the example user interface, a list of available aggregation rules (734) are provided with an explanation (736) of each selected rule provided next to the list.

According to some embodiment, the previews (722 and 726) may be updated automatically in response to subscriber selection of the aggregation rule giving the subscriber an opportunity to go back and modify the boundary values or status indicators.

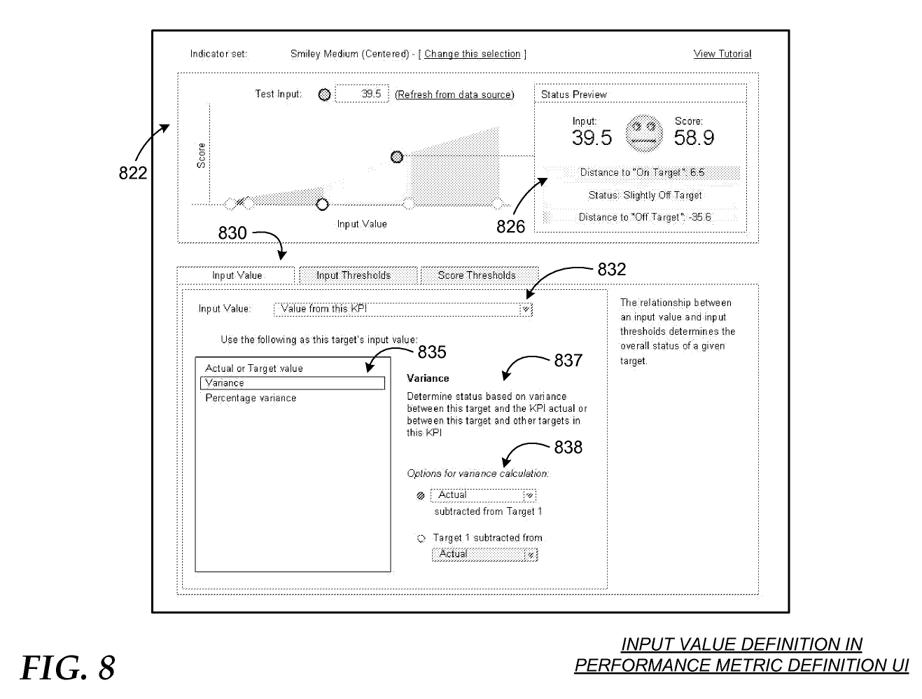

FIG. 8 is a screenshot of a performance metric definition user interface for defining an input value according to another method. The previews of the performance contour (822) and status (826) for a test input value are the same as in previous figures. Differently from FIG. 7, the input value is defined as a value for the selected KPI (832) in the example user interface 830 of FIG. 8. Based on this definition, different options for determining the input value are provided in the list 835, which includes actual or target values of the KPI, a variance between the target and the actual of the selected KPI or between different targets of the selected KPI, and a percentage variance between the actual and target(s) of the selected KPI. Depending on the selection in list 835, additional options for defining actuals and targets to be used in computation may be provided (838). An explanation (736) for each selection is also provided next to the list 825.

In other embodiments, the definition user interface may be configured to provide the option of selecting the input value based on an external value providing the subscriber options for defining the source for the external value.

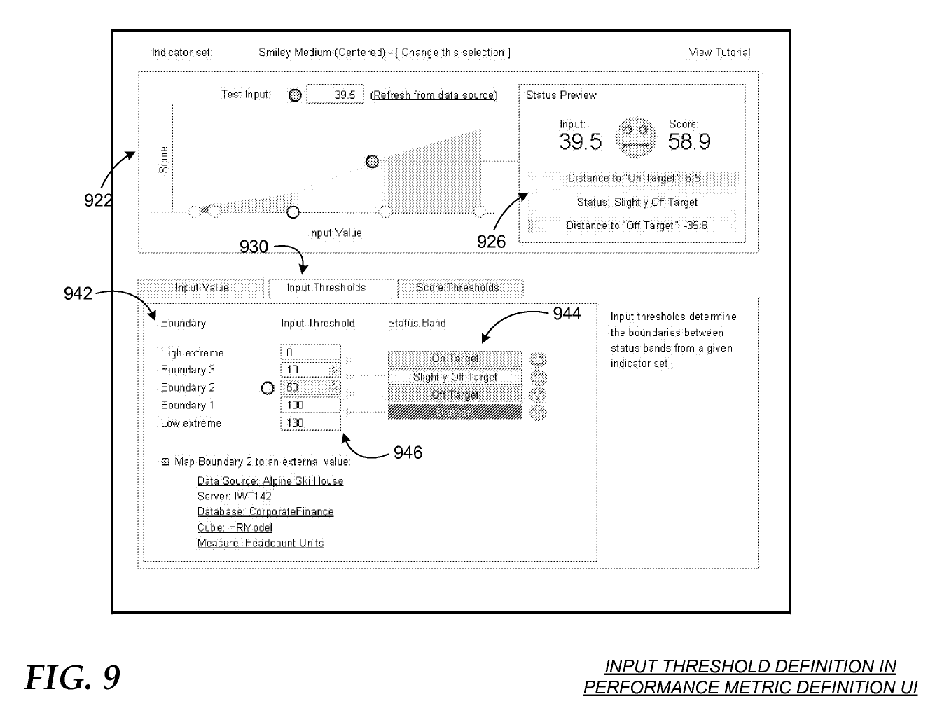

FIG. 9 is a screenshot of a performance metric definition user interface for defining input thresholds. Input thresholds determine the boundaries between status bands for a given indicator set.

The previews of the performance contour (922) and status (926) for a test input value are the same as in previous figures. In the definition user interface 930, input threshold parameters are displayed and options for setting or modifying them are provided. The parameters include input threshold values 946 for highest and lowest boundaries with other boundaries in between those two. The number of boundaries is based on the selected indicator set and associated number of statuses (944) displayed next to the list of boundary values. The names of the boundaries (942) are also listed on the left of the boundary value list.

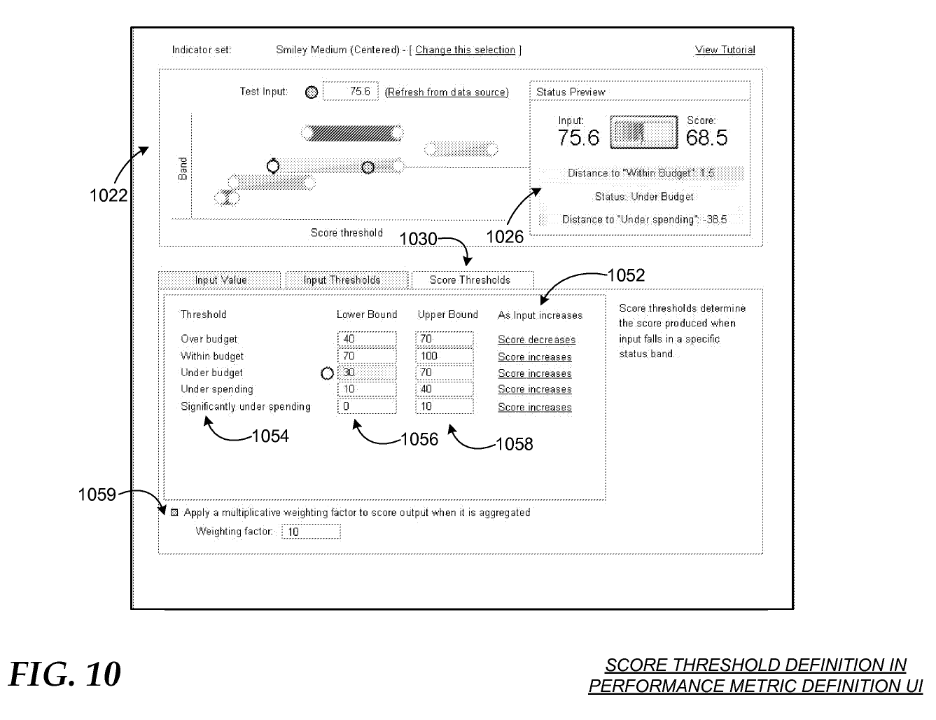

FIG. 10 is a screenshot of a performance metric definition user interface for defining score thresholds. Score thresholds determine the score produced when an input falls in a specific status band.

The previews of the performance contour (1022) and status (1026) for a test input value are functionally similar to those in previous figures. Differently in FIG. 10, score threshold preview displays bands between default boundary values along a score threshold axis with a test input value on one of the bands. The status preview 1026 also includes a gauge style indicator instead of a Smiley style indicator. Other indicator types may also be used according to embodiments.

The definition user interface includes a listing of thresholds 1054 (e.g. over budget, under budget, etc.), lower (1056) and upper (1058) boundary values, and the effect of what happens when the input increases within each threshold (1052). For example, as the input increases within the “over budget” threshold, the score decreases. On the other hand, in the “within budget” threshold the score may increase as the input increases. Thus, a behavior of the score within each threshold based on a behavior of the input value may be defined or modified at this stage and the performance contour adjusted accordingly.

According to some embodiments, a multiplicative weighting factor may be applied to the score output when the scores are aggregated. The weighting factor may be a default value or defined by the subscriber using definition user interface 1030 or another one.

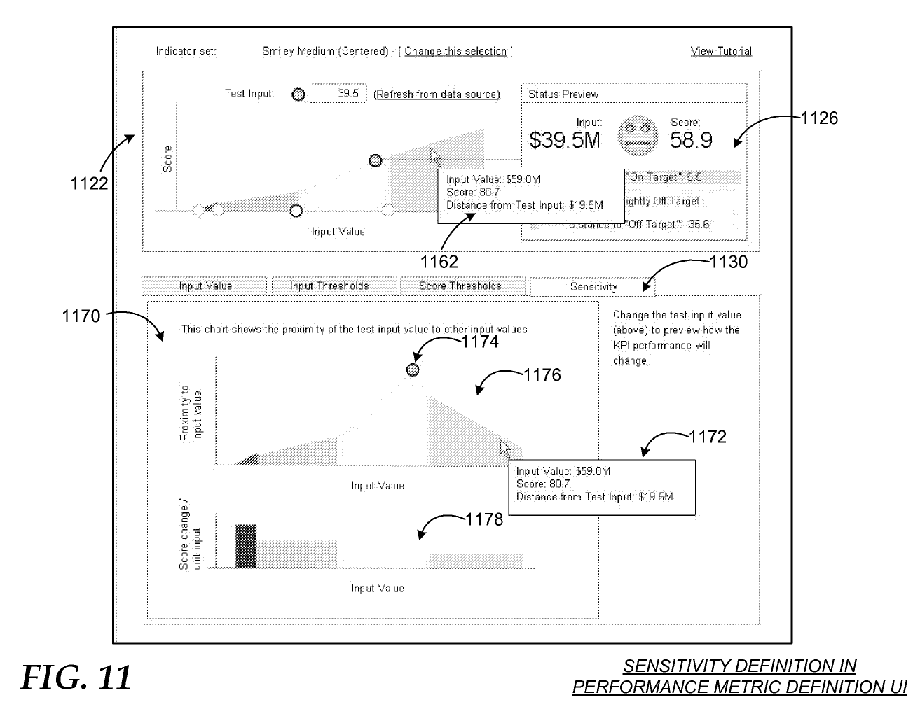

FIG. 11 is a screenshot of a performance metric definition user interface for testing the effects of proximity of a test input value to other input values. The previews of the performance contour (1122) and status (1126) for a test input value are the same as in FIG. 7. In addition, an information tip is provided showing a distance of an input value from the test value.

As illustrated under the “Sensitivity” tab of the example definition user interface, the subscriber may be provided with feedback by previewing how a KPI performance can change when the test input value is changed. A preview chart 1170 with the performance contour 1176 and the test input value may be displayed. When the subscriber selects another point on the performance contour, a distance of the new selection to the test input value and the new score may be provided instantaneously enabling the subscriber to determine effects of changes without having to redo the whole computation. A score change versus input value change chart 1178 may also be provided for visualization of the effects.

According to some embodiments, statistical analysis for past performance and/or future forecast may also be carried out based on subscriber definition (selection) of the computation parameters. A next step in the scorecard process is generation of presentations based on the performance metric data and the analysis results. Reports comprising charts, grid presentations, graphs, three dimensional visualizations, and the like may be generated based on selected portions of available data.

The example user interfaces and computation parameters shown in the figures above are for illustration purposes only and do not constitute a limitation on embodiments. Other embodiments using different user interfaces, graphical elements and charts, status indication schemes, user interaction schemes, and so on, may be implemented without departing from a scope and spirit of the disclosure.

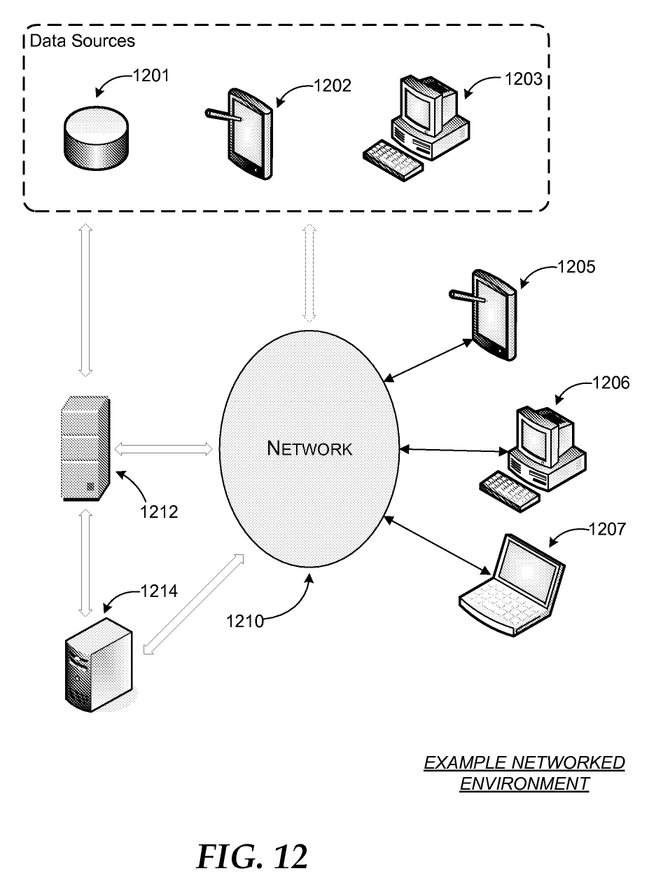

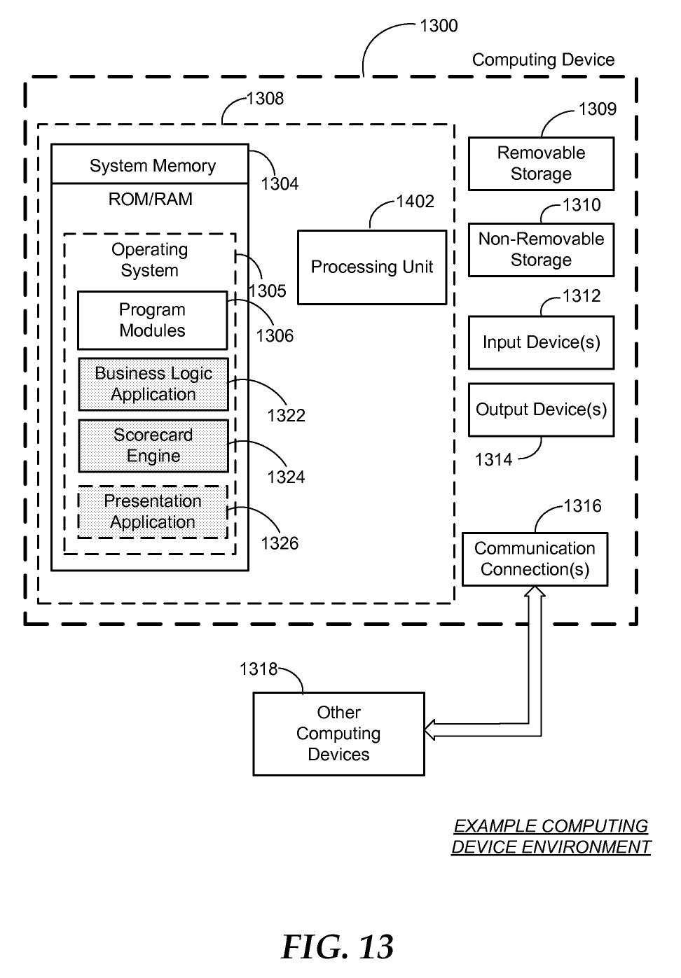

Referring now to the following figures, aspects and exemplary operating environments will be described. FIG. 12, FIG. 13, and the associated discussion are intended to provide a brief, general description of a suitable computing environment in which embodiments may be implemented.

FIG. 12 is a diagram of a networked environment where embodiments may be implemented. The system may comprise any topology of servers, clients, Internet service providers, and communication media. Also, the system may have a static or dynamic topology. The term “client” may refer to a client application or a client device employed by a user to perform operations associated with assessing severity of performance metrics using a quantitative model. While a networked business logic system may involve many more components, relevant ones are discussed in conjunction with this figure.

In a typical operation according to embodiments, business logic service may be provided centrally from server 1212 or in a distributed manner over several servers (e.g. servers 1212 and 1214) and/or client devices. Server 1212 may include implementation of a number of information systems such as performance measures, business scorecards, and exception reporting. A number of organization-specific applications including, but not limited to, financial reporting/analysis, booking, marketing analysis, customer service, and manufacturing planning applications may also be configured, deployed, and shared in the networked system.

Data sources 1201-1203 are examples of a number of data sources that may provide input to server 1212. Additional data sources may include SQL servers, databases, non multi-dimensional data sources such as text files or EXCEL® sheets, multi-dimensional data source such as data cubes, and the like.

Users may interact with server running the business logic service from client devices 1205-1207 over network 1210. In another embodiment, users may directly access the data from server 1212 and perform analysis on their own machines.

Client devices 1205-1207 or servers 1212 and 1214 may be in communications with additional client devices or additional servers over network 1210. Network 1210 may include a secure network such as an enterprise network, an unsecure network such as a wireless open network, or the Internet. Network 1210 provides communication between the nodes described herein. By way of example, and not limitation, network 1210 may include wired media such as a wired network or direct-wired connection, and wireless media such as acoustic, RF, infrared and other wireless media.

Many other configurations of computing devices, applications, data sources, data distribution and analysis systems may be employed to implement rendering of performance metric based presentations using geometric objects. Furthermore, the networked environments discussed in FIG. 12 are for illustration purposes only. Embodiments are not limited to the example applications, modules, or processes. A networked environment for may be provided in many other ways using the principles described herein.

With reference to FIG. 13, a block diagram of an example computing operating environment is illustrated, such as computing device 1300. In a basic configuration, the computing device 1300 typically includes at least one processing unit 1302 and system memory 1304. Computing device 1300 may include a plurality of processing units that cooperate in executing programs. Depending on the exact configuration and type of computing device, the system memory 1304 may be volatile (such as RAM), non-volatile (such as ROM, flash memory, etc.) or some combination of the two. System memory 1304 typically includes an operating system 1305 suitable for controlling the operation of a networked personal computer, such as the WINDOWS® operating systems from MICROSOFT CORPORATION of Redmond, Wash. The system memory 1304 may also include one or more software applications such as program modules 1306, business logic application 1322, scorecard engine 1324, and optional presentation application 1326.

Business logic application 1322 may be any application that processes and generates scorecards and associated data. Scorecard engine 1324 may be a module within business logic application 1322 that manages definition of scorecard metrics and computation parameters, as well as computation of scores and aggregations. Presentation application 1326 or business logic application 1322 itself may render the presentation(s) using the results of computations by scorecard engine 1324. Presentation application 1326 or business logic application 1322 may be executed in an operating system other than operating system 1305. This basic configuration is illustrated in FIG. 13 by those components within dashed line 1308.

The computing device 1300 may have additional features or functionality. For example, the computing device 1300 may also include additional data storage devices (removable and/or non-removable) such as, for example, magnetic disks, optical disks, or tape. Such additional storage is illustrated in FIG. 13 by removable storage 1309 and non-removable storage 1310. Computer storage media may include volatile and nonvolatile, removable and non-removable media implemented in any method or technology for storage of information, such as computer readable instructions, data structures, program modules, or other data. System memory 1304, removable storage 1309 and non-removable storage 1310 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1300. Any such computer storage media may be part of device 1300. Computing device 1300 may also have input device(s) 1312 such as keyboard, mouse, pen, voice input device, touch input device, etc. Output device(s) 1314 such as a display, speakers, printer, etc. may also be included. These devices are well known in the art and need not be discussed at length here.

The computing device 1300 may also contain communication connections 1316 that allow the device to communicate with other computing devices 1318, such as over a network in a distributed computing environment, for example, an intranet or the Internet. Communication connection 1316 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

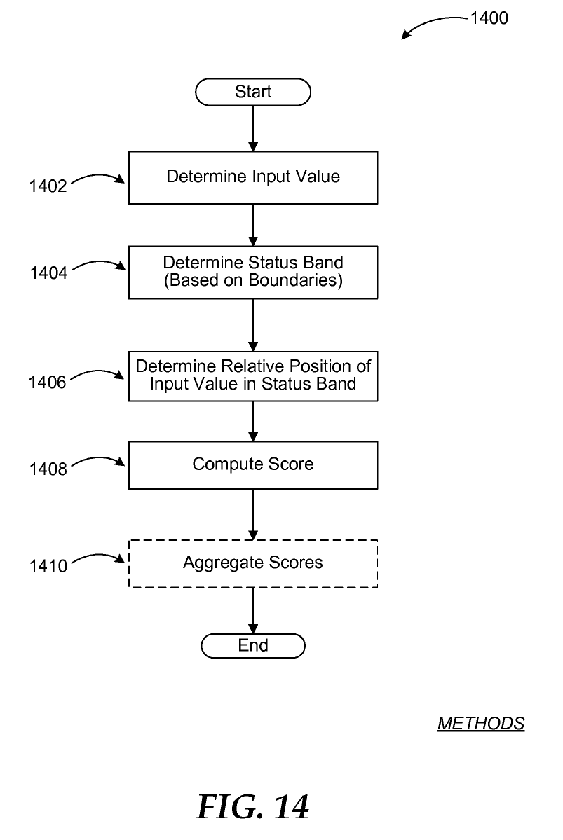

FIG. 14 illustrates a logic flow diagram for a process of severity assessment for performance metrics using a quantitative model. Process 1400 may be implemented in a business logic service that processes and/or generates scorecards and scorecard-related reports.

Process 1400 begins with operation 1402, where an input value for a target of a performance metric is determined. The input may be provide by a subscriber or obtained from a variety of source such as other applications, scorecard data store, and the like. Processing advances from operation 1402 to operation 1404.

At operation 1404, a status band is determined. Each performance metric target has associated status bands defined by boundaries. The status band may be selected based on the boundaries and the input value. Determination of the status band also determines the status icon, text, or other properties to be used in presenting a visualization of the metric. Processing proceeds from operation 1404 to operation 1406.

At operation 1406, a relative position of the input value within the status band is determined. The relative position of the input value is determined by determining the relative distance between boundary values within the status band. Processing moves from operation 1406 to operation 1408.

At operation 1408, the score for the performance metric is computed. The score is computed based on the relative position of the input value within the status band and a range of scores available within the status band. Processing advances to optional operation 1410 from operation 1408.

At optional operation 1410, the score is used to perform aggregation calculations using other scores from other performance metrics. As described previously, scores may be aggregated according to a default or user defined rule and the hierarchical structure of performance metrics reporting to a higher metric. The aggregation result(s) may then be used with the scores of the performance metrics to render presentations based on user selection of a presentation type (e.g. trend charts, forecasts, and the like). After optional operation 1410, processing moves to a calling process for further actions.

The operations included in process 1400 are for illustration purposes. Assessing severity of performance metrics using a quantitative model may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for assessing severity of a performance metric within a scorecard structure, the method comprising:
receiving performance metric data;
determining an input value for the performance metric;
determining a set of boundaries for a status band associated with the performance metric;
determining the status band based on the input value and the boundaries;
determining a relative position of the input value within the status band; and
computing a score for the performance metric based on the relative position of the input value and a range of scores available within the status band.

2. The method of claim 1, wherein the input value is received from a subscriber.

3. The method of claim 1, wherein the input value is determined from a computed value.

4. The method of claim 1, wherein the set of boundaries is determined based on a number of statuses associated with the status band.

5. The method of claim 4, further comprising:
determining at least one from a set of: a status icon, a status label, and an attribute for visualization of the performance metric based on the status band.

6. The method of claim 1, wherein the relative position of the input value is determined based on a relative distance between the boundaries within the status band.

7. The method of claim 1, further comprising:
defining at least one input threshold based on a number of boundaries available for a selected indicator set.

8. The method of claim 7, further comprising:
defining at least one score threshold based on the status band such that the score is determined based on a position of an input within the status band.

9. The method of claim 1, further comprising:
providing a visual feedback to a subscriber using at least one from a set of: an icon, a coloring scheme, a textual label, and a composite object.

10. The method of claim 1, further comprising:
enabling a subscriber to modify a number and position of the boundaries through an authoring user interface.

11. The method of claim 1, further comprising:
computing at least one additional score for the same performance metric, wherein each score is associated with a distinct target.

12. The method of claim 1, further comprising:
dynamically adjusting an input threshold defining status band regions and a score threshold defining score values for corresponding input thresholds based on a subscriber modification of one of: a boundary and an indicator set.

13. The method of claim 1, further comprising:
aggregating scores for a plurality of performance metrics according to a hierarchic structure of the plurality of performance metrics employing a predefined rule.

14. The method of claim 1, wherein the predefined rule includes at least one from a set of: sum of child scores, mean average of child scores, maximum of child scores, minimum of child scores, sum of descendant scores, mean average of descendant scores, maximum of descendant scores, minimum of descendant scores, a variance between an aggregated actual and an aggregated target, a standard deviation between an aggregated actual and an aggregated target, a result based on a count of child scores, and a result based on a count of descendent scores.

15. A system for performing a scorecard computation based on aggregating performance metric scores, the system comprising:
a memory;
a processor coupled to the memory, wherein the processor is configured to execute instructions to perform actions including:
receive performance metric data from one of a local data store and a remote data store;
determine an input value for each performance metric by one of:
receiving from a subscriber and computing from a default value;
determine a set of boundaries for a status band associated with each performance metric, wherein the boundaries define input thresholds for each status band;
determine the status band based on the input value and the boundaries;
determine a visualization scheme based on one of: the status band and a subscriber selection;
define at least one score threshold based on the status band such that the score is determined based on a position of an input within the status band;
determine a relative position of the input value within the status band based on a relative distance between the boundaries within the status band;
compute a score for each performance metric based on the relative position of the input value and a range of scores available within the status band of each performance metric; and
aggregate scores for selected performance metrics according to a hierarchic structure of the selected performance metrics employing a predefined rule.

16. The system of claim 15, wherein the processor is further configured to:
provide a preview of a selected presentation based on the computed scores;
enable the subscriber to adjust at least one of the boundaries; and
dynamically adjust the input thresholds and the score thresholds based on the subscriber adjustment.

17. The system of claim 15, wherein the processor is further configured to:
cache at least a portion of the performance metric data, the computed scores, and status band parameters;
render a presentation based on the performance metric data and the computed scores; and
automatically filter the presentation based on a dimension member selection using the cached data.

18. The system of claim 15, wherein the processor is further configured to:
provide a preview of a selected presentation based on the computed scores;
enable the subscriber to define a test input value; and
provide a feedback on score changes based on a proximity of the test input value to other input values.

19. A computer-readable storage medium with instructions stored thereon for a scorecard computation based on aggregating performance metric scores, the instructions comprising:
receiving an input value for each performance metric from a subscriber;
determining a set of boundaries for a status band associated with each performance metric, wherein the boundaries define input thresholds for each status band;
determining each status band based on the associated input value and boundaries, wherein the status bands;
defining score thresholds based on the status bands such that a score for each performance metric is determined based on a position of an input within the status band for that performance metric;
determining a default visualization scheme comprising status icons, status labels, and attributes based on the status bands;
determining a relative position of the input value within the status band based on a relative distance between the boundaries within the status band;
computing a score for each performance metric based on the relative position of the input value and a range of scores available within the status band of each performance metric;
providing a presentation preview based on the computed score for each performance metric;
enabling the subscriber to modify at least one of the boundaries and the visualization scheme through an authoring user interface;
dynamically adjusting the input and score thresholds and recomputing the scores based on a subscriber modification; and
aggregating the scores for selected performance metrics according to a hierarchic structure of the selected performance metrics employing a predefined rule.

20. The computer-readable storage medium of claim 19, wherein each performance metric is associated with a plurality of targets and each score is an aggregation of scores determined for each target of a performance metric.
